(19) United States
(12) Patent Application Publication
(10) Pub. No.: US 2005/0280404 A1
(43) Pub. Date: Dec. 22, 2005

(54) Current replication to avoid LEB restriction of DC-DC boost converter

(75) Inventor: Andrew P. LeFevre, Great dunmow Essex (GB)

Correspondence Address: LAW OFFICES OF GARY R. STANFORD, 330 W OVERLOOK MOUNTAIN RD, BUDA, TX, 78610, US

(73) Assignee: Intersil Americas Inc., Milpitas, CA (US)

(21) Appl. No.: 10/965,345

(22) Filed: Oct. 14, 2004

(30) Foreign Application Priority Data
Jun. 16, 2004 (GB) 0413494.6

(51) Int. Cl. G05F 1/40

(52) U.S. Cl. 323/282

(57) ABSTRACT

A current replication circuit that avoids the LEB period restriction of a DC-DC boost converter. The DC-DC boost converter regulates an output voltage by switching an input voltage through an inductor and a diode using a switch controller employing current feedback control and providing a PWM signal to control a switch coupled to the inductor. The current replication circuit includes a current sensor, a ramp generator, and a summing device. The current sensor samples current through the inductor while the switch is off and provides a sample voltage indicative of inductor current just before the switch is turned on. The ramp generator provides a ramp voltage replicating current increase of the inductor while the switch is on. The summing device adds the sample voltage to the ramp voltage to develop a replication voltage used for feedback current control by the switch controller.

### CROSS-REFERENCE TO RELATED APPLICATIONS

This application claims the benefit of British Patent Application No. 0413494.6, filed on Jun. 16, 2004, which is herein incorporated by reference for all intents and purposes.

### BACKGROUND OF THE INVENTION

1. Field of the Invention

The present invention relates to DC-DC converters employing current feedback, and more particularly to a current replication circuit which enables elimination of the leading edge blanking (LEB) period of a DC-DC boost converter to remove the duty cycle restriction.

2. Description of the Related Art

A conventional DC-DC boost converter switches current through an inductor and diode to convert an input voltage to a larger, regulated output voltage. The switching is typically performed by an electronic switch, such as a metal-oxide semiconductor, field-effect transistor (MOSFET), which has its gate controlled by a pulse-width modulation (PWM) control signal. The drain and source path of the MOSFET is coupled between the inductor/diode junction and a sense resistor referenced to a common node, such as ground. A switch controller monitors the output voltage through a voltage feedback signal and monitors the inductor current via the voltage of the sense resistor, and uses this and other information, as known to those of ordinary skill in the art, to develop the PWM control signal.

In operation, the switch controller closes the switch (e.g., turns on the MOSFET) to initiate the first phase of each PWM cycle effectively placing the input voltage across the inductor and sense resistor. The voltage across the sense resistor, representing the inductor current, linearly rises over time and this sense voltage is monitored by the switch controller during the first portion of each PWM cycle. The feedback current sense signal is compared with a reference value to determine, at least in part, when to next turn off the electronic switch to initiate the second phase of each PWM cycle. When the switch is turned off (or opened), the built-up inductor current forward biases the diode and flows into an output capacitor to develop the output voltage. Operation repeats in this manner for each PWM cycle. The converter is known as a “boost” converter since the DC output voltage is greater than the DC input voltage.

A particular problem with the conventional DC-DC boost converter is the leading-edge ringing that occurs on the inductor current when the switch is turned on (or closed). Parasitic capacitance of the switch combined with line inductance and the sense resistance collectively form a tank circuit which causes the sense voltage to oscillate (e.g., a damped sinusoidal oscillation) each time the switch is turned on. The switch controller employs a leading edge blanking (LEB) period in which it ignores the initial ringing of the current sense voltage. In particular, the T_{LEB} period is used to ignore the initial ringing to prevent premature termination at the beginning of each PWM cycle. The T_{LEB} period, however, restricts the minimum duty cycle of the boost converter and therefore limits the output voltage range for a given input voltage. For example, the use of the T_{LEB} period, while avoiding the potentially debilitating results of using a ringing signal for purposes of feedback control, prevents a lower duty cycle to be used so that the output voltage is not allowed to be close to the input voltage.

Historically, this problem has been solved by the combination of both a DC-DC converter and a regulator. Such solution is inherently inefficient in terms of power consumption and the number of components needed. It is desired to provide an efficient DC-DC boost converter that avoids regulation based on an oscillatory signal and that enables the output voltage to relatively close to the input voltage level.

### SUMMARY OF THE INVENTION

A current replication circuit according to an embodiment of the present invention avoids the LEB period restriction of a DC-DC boost converter. The DC-DC boost converter regulates an output voltage by switching an input voltage through an inductor and a diode using a switch controller employing current feedback control and providing a pulse-width modulation (PWM) signal to control a switch coupled to the inductor. The current replication circuit includes a current sensor, a ramp generator, and a summing device. The current sensor samples current through the inductor while the switch is off and provides a sample voltage indicative of inductor current just before the switch is turned on. The ramp generator provides a ramp voltage replicating current increase of the inductor while the switch is on. The summing device adds the sample voltage to the ramp voltage to develop a replication voltage used for feedback current control by the switch controller.

In this manner, rather than sensing the actual current through the inductor, where the actual current exhibits ringing cause by parasitic inductance and capacitance, the current through the inductor is replicated and the replicated current is used for current feedback control. The first phase of each PWM cycle, during which the input voltage is applied to the inductor causing current build-up in the inductor, may be terminated earlier thereby allowing a significantly reduced duty cycle than that previously allowed because of the LEB period restriction. The output voltage, in turn, can be controlled to a level significantly closer to the input voltage.

Several variations and embodiments are contemplated. The current sensor may be sample and hold device that samples the current through the inductor before switching and that holds the sample voltage after switching. In one embodiment, a current mirror is coupled to the diode to provide a mirror current indicative of current through the diode. In one case, the sample and hold device is coupled to the current mirror to hold a sample of the mirror current as the sample voltage. The switch controller may provide a preliminary PWM signal to a buffer which provides the PWM signal. The buffer generally delays the PWM signal relative to its preliminary counterpart. The preliminary PWM signal is provided to control the sample and hold device so that the sample voltage is taken before switching. The ramp generator may be configured to synthesize build-up of the inductor current based on the input voltage divided by the inductance of the inductor. A gain block may be provided to multiply the replication voltage by a scale factor to simulate or replicate the voltage sense signal, which was previously developed on a sense resistor coupled to the switch and thus measuring actual inductor current.

A DC-DC converter according to an embodiment of the present invention includes an inductor having a first end receiving an input voltage relative to a common node, a diode having an anode coupled to a second end of the inductor, a capacitor coupled between the cathode of the diode and the common node developing an output voltage, a switch device having a controlled current path coupled between the second end of the inductor and the common node and a control input used to enable or disable the current path, a switch controller having an input receiving a current sense signal and an output providing a PWM control signal to the control input of the switch device, a ramp generator providing a ramp signal having a slope simulating current increase through the inductor while the switch device is turned on, a current sensor that provides a current sample signal indicative of the current level through the diode while the switch device is off and just before the switch device is turned on, and a summing device that adds the ramp and current sample signals together to provide a replication signal used for the current sense signal.

Several variations and embodiments are contemplated. The switch device may be a metal-oxide semiconductor, field-effect transistor (MOSFET) or any other suitable type of electronic switching device. The current sensor may be a sample and hold circuit that samples current and that holds a sample voltage as the current sample signal indicative of sampled current. A current mirror may be coupled to the diode for providing a mirror current, and the current sensor may be a sample and hold circuit that is coupled to the current mirror to sample the mirror current and to hold a sample voltage as the current sample signal indicative of sampled current. The switch controller may include a buffer which has an input receiving a preliminary PWM signal and an output providing the PWM control signal. The preliminary PWM signal is provided to the sample and hold circuit, which holds the current sample signal in response to the preliminary PWM signal. A gain block may be provided to multiply the replication signal by a scale factor to develop the current sense signal.

A method of eliminating the LEB period restriction of a DC-DC boost converter according to an embodiment of the present invention enables reduced PWM duty cycle and an output voltage that is significantly closer to the input voltage than that previously allowed because of the LEB period restriction. The method includes determining current level of the inductor while the switch is open and just before the switch is closed and providing a corresponding current level signal, synthesizing current increase of the inductor while the switch is closed and providing a corresponding ramp signal, and adding the current level and ramp signals together to develop a current feedback sense signal provided to the sample controller.

The method may include generating a preliminary PWM signal and buffering the preliminary PWM signal to provide the PWM control signal. The method may include sampling current and holding a current sample in response to the preliminary PWM signal. The sampling and holding may include converting sampled current to a voltage sample. The buffering of the preliminary PWM signal may include delaying the PWM control signal to ensure sampling before switching. The method may include generating the ramp signal based on the input voltage and the inductance of the inductor.

### BRIEF DESCRIPTION OF THE DRAWINGS

The benefits, features, and advantages of the present invention will become better understood with regard to the following description, and accompanying drawings where:

FIG. 1 is a simplified schematic diagram of a conventional DC-DC boost converter;

FIG. 2 is a graph diagram of the ideal current waveforms in the inductor of FIG. 1, including contiguous waveforms in the current sense element and the diode when the switch is open;

FIGS. 3A and 3B are graph diagrams illustrating more realistic (e.g., actual) representations of the current through the inductor of FIG. 1 during each phase of the PWM cycle illustrating the combined effect of ringing due to parasitic inductance and capacitance;

FIG. 4 is a simplified schematic diagram of a DC-DC boost converter implemented according to an embodiment of the present invention that overcomes the T_{LEB} period limitation;

FIG. 5A is a graph diagram of the ramp generator representing the build up in current in the inductor of FIG. 4 while the switch is turned on;

FIG. 5B is graph diagram of measured or sampled current in the inductor and diode of FIG. 4 while the switch is turned off and just prior to the switch being turned on;

FIG. 5C is a graph diagram of the summation and sense voltages representing the switch path current information simulated by summing the ramp voltage of FIG. 5A and the sampled inductor current of FIG. 5B and optionally multiplying by a scale factor; and

FIG. 6 is a more detailed schematic and block diagram illustrating further details for sampling current through the diode and timing associated with holding a sample of the measured current for the DC-DC boost converter of FIG. 4 according to an exemplary embodiment of the present invention.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

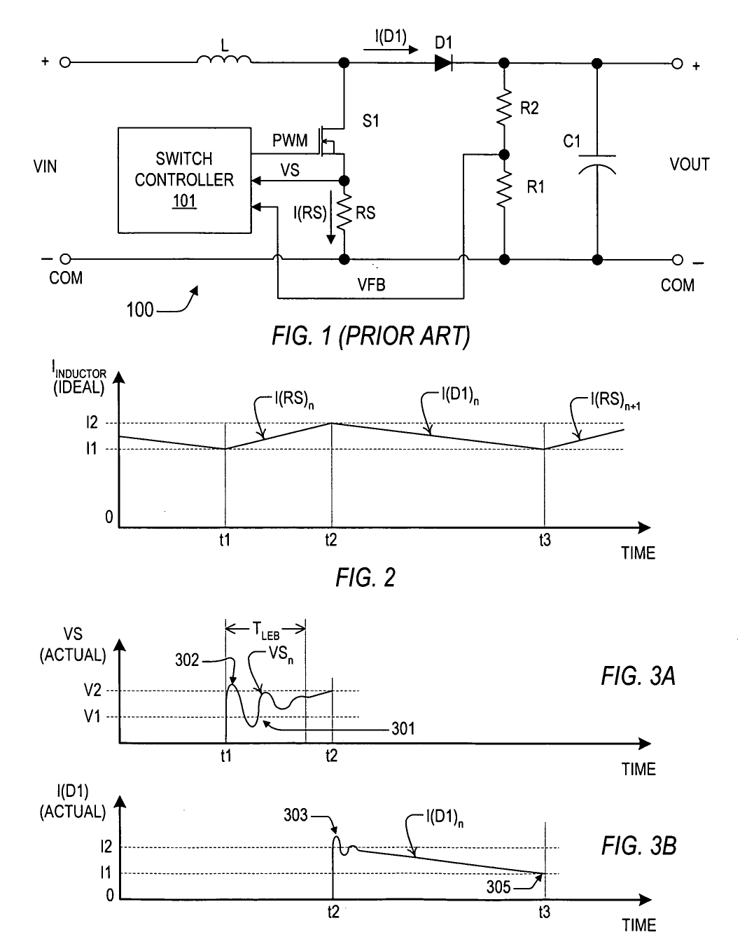

FIG. 1 is a simplified schematic diagram of a conventional DC-DC boost converter 100. An input voltage VIN measured with respect to a common node COM (e.g., ground or “power ground”) is applied to one end of an inductor L, having its other end coupled to the drain of a MOSFET switch S1 and to the anode of a diode D1. The switch S1 is shown as a MOSFET, although any other suitable type of electronic switch is contemplated. In general, the switch S1 includes a control input (e.g., gate) and a current path (e.g., drain-source) that is controlled by the control input. Any type of device performing a controlled single-pole, double-throw (SPST) function is contemplated. The source of the switch S1 is coupled to one end of a sense resistor RS, having its other end coupled to COM. The current through the current sense resistor RS is shown as I(RS). The current sense resistor RS develops a sense voltage VS at the source of the switch S1, where VS is provided to a switch controller 101. The switch controller 101 provides a pulse-width modulation (PWM) control signal to the gate of the switch S1. The cathode of the diode D1 is coupled to one end of a resistor R2 and to one end of a capacitor C1 at an output node that develops the output voltage VOUT. The current through the diode D1 is shown as I(D1). The other end of the capacitor C1 is coupled to COM and the other end of the resistor R2 is coupled to one end of a resistor R1, having its other end coupled to COM. The junction between the series-coupled resistors R1 and R2 develops an output voltage feedback signal VFB, which is fed back to the switch controller 101. For the boost converter 100, the output voltage VOUT is greater than the input voltage VIN.

FIG. 2 is a graph diagram of the ideal current waveform of the inductor L of the boost converter 100 (shown as I_{INDUCTOR}), including contiguous waveforms of the current sense resistor RS (i.e., I(RS)) when switch S1 is turned on (or closed) and of the diode D1 (i.e., I(D1)) when the switch S1 is turned off (or opened). The subscripts of the current values are integer values denoting consecutive PWM cycle numbers. In particular, a first PWM cycle “n” begins at time t1 initiating a first phase illustrated by an ideal current I(RS)ₙ from t1 to a time t2 followed by a second phase of PWM cycle n from time t2 to a time t3 illustrated by an ideal current I(D1)ₙ. The next PWM cycle “n+1” begins at time t3 as illustrated by an ideal current I(RS)ₙ₊₁, and so on. In conventional operation, the switch controller 101 monitors the VFB and VS signals to toggle the PWM signal to turn on and off the switch S1 to regulate VOUT to a predetermined voltage level, or otherwise to regulate the inductor current between minimum and maximum values (e.g., I1 and I2, respectively). Although not shown, the switch controller 101 includes feedback sense and control circuitry or logic as known to those of ordinary skill in the art, such as including multiple transconductance (gm) stages and/or summing amplifiers, a current slope compensation signal (e.g., triangular or sawtooth waveform or the like) generator, etc., to develop the PWM signal to control the loop for regulating VOUT.

When the switch S1 is turned on at a time t1 effectively coupling its drain to source together, the input voltage VIN is effectively placed across the inductor L and the relatively small-valued resistor RS. During this first phase of the PWM cycle, the ideal current through the inductor L increases linearly as shown by I(RS)ₙ from the low value I1 to the high value I2. When the switch S1 is turned off thus effectively disconnecting the inductor L from the resistor RS, the energy built up in the inductor L causes the ideal current I(D1)ₙ to flow through the diode D1 to charge the output capacitor C1 and develop the output voltage VOUT. The current I(D1)ₙ linearly decreases from I2 at time t2 back to I1 at time t3, at which time the switch S1 is again turned on to initiate the next PWM cycle n+1.

FIGS. 3A and 3B are graph diagrams illustrating more realistic (e.g., actual) representations of the current through the inductor L during each phase of the PWM cycle illustrating the combined effect of ringing due to parasitic inductance and capacitance. FIG. 3A is a graph diagram of the voltage VS between times t1 and t2, or VSₙ, which represents I(RS)ₙ. Low and high voltage levels V1 and V2 are shown representing the low and high current levels I1 and I2, respectively. The MOSFET switch S1 incorporates a significant amount of parasitic capacitance, which combines with parasitic inductance of the circuit (e.g., conductive traces, chip pin connections, etc.) and resistance (e.g., RS and other stray resistance) collectively forming an oscillatory tank circuit. When S1 is turned on at time t1 initiating the nth PWM cycle, leading edge ringing (e.g., a damped sinusoidal waveform) occurs on the VSₙ signal after time t1 as shown at 301. Note, for example, that the ringing has an initial high peak 302 potentially exceeding V2 (representing I2), which might otherwise cause premature termination of the first phase of the PWM cycle if directly used as the feedback signal. DC-DC converters employing current feedback, including the boost converter 100, typically employ a leading edge blanking (LEB) period, or T_{LEB}, which prevents the effects of such ringing from disturbing operation of the feedback loop. The T_{LEB} period is arbitrarily set with a sufficient duration to ignore such ringing until it dies out and thus to prevent premature termination at the beginning of each PWM cycle.

The T_{LEB} period used to prevent premature termination of the first phase of the PWM cycle restricts the minimum duty cycle of the boost converter 100 and therefore limits the output voltage range for a given input voltage. For the boost converter 100, for example, the use of the T_{LEB} period does not allow a very low duty cycle to be implemented so that the output voltage VOUT is forced to be significantly greater than VIN. The switch controller 101 includes an internal comparator or the like (not shown), which compares the VS voltage with a reference value to determine when the inductor current has reached a predetermined high (or maximum) level. In many configurations, it is desired to reduce the difference in time from t2 to t1, or t2−t1, to cause time t2 to occur earlier in time thereby reducing the duty cycle of the PWM control signal. The reduction in PWM duty cycle, in turn, enables reduction of the level of the output voltage VOUT so that it is closer to the level of VIN. The T_{LEB} period employed to avoid the ringing 301 of the VS signal, however, forces an artificial minimum limit on the PWM duty cycle. By the time the T_{LEB} period expires, the VS voltage is greater than the desired target level artificially forcing VOUT to be significantly greater than VIN.

Historically, this problem has been solved by the combination of both a DC-DC converter and a regulator. Such solution is inherently inefficient in terms of power consumption and the number of components needed.

FIG. 3B is a graph diagram of the diode current I(D1) between times t2 and t3, or I(D1)ₙ. In the configuration illustrated, the ringing 303 of the I(D1) current beginning at time t2 when the switch S1 is turned off is less problematic since not being monitored for purposes of control, and thus is ignored for purposes of the present invention. It is noted, however, that the I(D1)ₙ current is relatively stable at the end of the second phase of the PWM cycle just before time t3 as shown at 305.

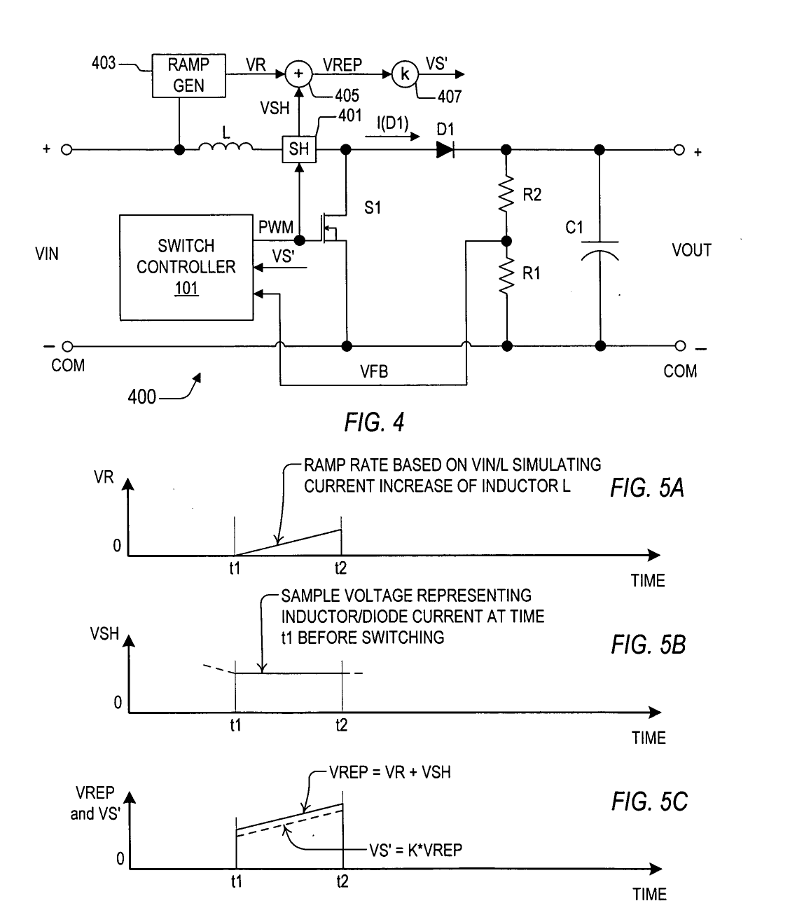

FIG. 4 is a simplified schematic diagram of a DC-DC boost converter 400 implemented according to an exemplary embodiment of the present invention that overcomes the T_{LEB} period limitation. The boost converter 400 has a similar configuration as the boost converter 100 where similar components are shown with the same reference numbers. The sense resistor RS is removed as unnecessary so that the source of the switch S1 is coupled directly to COM. A current sense device 401 is coupled in the current path between the inductor L and the diode D1 for sensing the diode current I(D1) and for developing a corresponding sense voltage VSH. In the particular embodiment illustrated, the current sense device 401 is a sample and hold (SH) device which samples the current I(D1) at a prescribed time and provides a corresponding sampled voltage VSH representing a snapshot of I(D1). In one embodiment, the current sense device 401 continuously samples the current I(D1) and holds a sampled value just about when the I(D1) current has fallen to the lower level I1 and just before the switch S1 is turned on again to initiate the next PWM cycle (e.g., at times t1, t3, etc.). Thus, the current is sampled at the very end of each PWM cycle, such as shown at 305 of FIG. 3B.

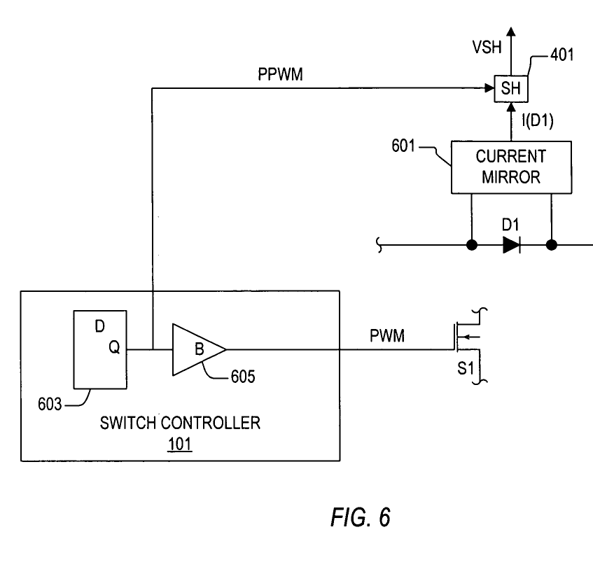

The PWM signal from the switch controller 101 is shown provided to the current sense device 401 so that just before the PWM signal is asserted to the appropriate level to turn on the switch S1, the VSH sample is taken. It is noted that it is desired that the sample be taken before the switch S1 is actually turned on to avoid the effects of the ringing 301. If the PWM signal is used, the current sense device 401 is configured to hold the sample before the switch S1 is turned on. In actual configuration implementations, a different or preliminary PWM signal is provided to the current sense device 401 to cause it to hold a sampled value before the switch S1 is actually turned on to ensure that the sample is taken in time at the end of the PWM cycle before switching. It is possible to relay the PWM signal through the current sense device 401, which controls the switch S1 to ensure that the sample is taken prior to activation of the switch S1. However, this would require that the current sense device 401 include buffer circuitry or the like sufficient to drive the gate of S1. In one embodiment, a preliminary PWM signal, called PPWM (FIG. 6) is provided to the current sense device 401 to ensure sampling prior to switching, as further described below. Many different and alternative embodiments are contemplated for implementing the current sense device 401.

The boost converter 400 also includes a ramp generator 403 which generates a ramp voltage VR representing the build up or rise in current in the inductor L while the switch S1 is turned on, as further described below. The VR and VSH signals are provided to respective inputs of a summing device 405, which adds the voltage signals together to develop a replication voltage signal VREP provided at its output. The VREP signal is provided to a multiplier or gain block 407, which multiplies the VREP signal by a scale factor “k” and outputs a current feedback sense signal VS′=k*VREP (where the asterisk “*” denotes multiplication). The current feedback sense signal VS′ is provided to the switch controller 101 in lieu of the VS signal. The scale factor “k” is typically less than one (1) and converts the VREP signal to the voltage level of the VS signal as though sensing voltage across the sense resistor RS and representing current through the switch S1 while the switch S1 is turned on.

FIGS. 5A-5C are graph diagrams of the ramp voltage VR, the sample and hold voltage VSH, and the summation and scaled voltages VREP and VS′, respectively. FIG. 5A shows the ramp voltage VR developed by the ramp generator 403 representing the build up in current in the inductor L while the switch S1 is turned on. In one embodiment, a circuit block, such as the ramp generator 403 itself, monitors VIN and, since the inductance (e.g., inductance=L) of the inductor is known, generates VR equal to or otherwise proportional to VIN/L (where the forward slash “/” denotes division). As shown, VR ramps up from zero in a linear manner between times t1 and t2 simulating the ramp up of the current I(RS) between times t1 and t2. FIG. 5B shows VSH representing measured current in the inductor L sampled just prior to time t1, which is also equivalent to the current through the diode D1 since the switch S1 is off and the inductor L and diode D1 are effectively coupled in series. As shown, VSH is sampled at about time t1 at some voltage level and remains constant from t1 to t2. FIG. 5C shows VREP at the output of the summing device 405. Since VSH is a voltage representing the initial current I(D1) of the diode D1 just before the switch S1 is turned on, and since VR represents the build up of current of the inductor L after the switch S1 is turned on, then VREP is a voltage representing the current flowing through the switch S1 when turned on between times t1 and t2 for the nth PWM cycle. Operation is repeated for each PWM cycle in similar manner. VREP is scaled by the scale factor “k” to develop VS′, also shown in FIG. 5C, which simulates the voltage previously developed across the sense resistor RS between times t1 and t2.

FIG. 6 is a more detailed schematic and block diagram illustrating further details for sampling current through the diode D1 and the timing associated with holding a sample of the measured current for the DC-DC boost converter 400 according to an exemplary embodiment of the present invention. A current mirror 601 is shown coupled across the diode D1 providing an appropriately scaled version of the sampled current I(D1) to the current sense device 401. In this case, the current sense device 401 is a sample and hold device which continuously samples I(D1) and then holds a sample at its output as the VSH signal when the preliminary PWM signal, or PPWM, is asserted initiating the next PWM cycle. The switch controller 101 includes a latch or flip-flop device or the like, such as a D-type flip flop 603, which outputs the PPWM signal when its internal feedback control circuitry (not shown) determines to initiate the next PWM cycle. The PPWM signal is a digital or binary signal or the like that is not directly used to drive the gate of the switch S1. Instead, the PPWM signal is buffered through a buffer device 605, which outputs the PWM signal to the gate of S1. In one embodiment, the buffer device 605 includes multiple series-coupled buffers or inverters or the like to boost the PWM signal to the appropriate power level or drive capacity to drive the gate of S1. The buffer device 605 inserts a delay, such as on the order of several nanoseconds (ns) (e.g., ˜20 ns), so that the PPWM signal is asserted prior to the PWM signal. In this manner, the current sense device 401 receives the PPWM signal and outputs a sample of the I(D1) signal as the VSH signal just before the PWM signal is asserted to turn on the switch S1. The use of the PPWM signal to control sampling and the slightly delayed PWM signal to control switching ensures sampling prior to switching.

The DC-DC boost converter 400 implements a new solution in that instead of using the current I(RS) in the switching path for purposes of feedback loop control, the boost converter 400 monitors or otherwise samples the current I(D1) through the diode D1 and replicates the build-up of current through the inductor L to re-synthesize or otherwise simulate the inductor current increase through the switching device without the ringing noise caused by parasitic inductance and capacitance. Since the ringing of the current feedback information is avoided for purposes of feedback control, the T_{LEB} period restriction of the PWM duty cycle is overcome so that the boost converter 400 may operate with a very low duty cycle. In particular, the first phase of each PWM cycle is terminated based on the VS′ signal, which may occur at any time before the expiration of the typical T_{LEB} period, enabling a reduced PWM duty cycle. A lower duty cycle enables the output voltage VOUT to approach the level of the input voltage VIN unlike conventional DC-DC boost converters.

The sense resistor RS may optionally be eliminated improving efficiency by reducing power losses. The ramp generator 403, summing device 405 and the gain block 407 may be implemented within the switch controller 101. It is noted, however, that additional devices provided external to the switch controller 101 enables the switch controller 101 to remain unmodified. The VREP voltage may be directly used rather than VS′ if properly scaled (such as by configuration of the switch controller 101 or pre-scaling or direct scaling of the VR and VSH voltages). A portion of the DC-DC boost converter 400 may be implemented on a common control chip or integrated circuit (IC). In one embodiment, for example, the switch controller 101, the switch S1, the current sense device 401, the ramp generator 403, the summing device 405, the gain block 407, the current mirror 601 and the diode D1 are integrated onto a common controller chip. Such configuration is particularly advantageous since flip-flops, buffers, ramp generators, summing devices, sample and hold circuits, and current mirrors are common devices that are easily implemented on an IC.

Although the present invention has been described in considerable detail with reference to certain versions thereof, other versions and variations are possible and contemplated. Those skilled in the art should appreciate that they can readily use the disclosed conception and specific embodiments as a basis for designing or modifying other structures for providing out the same purposes of the present invention without departing from the spirit and scope of the invention as defined by the appended claims.

1. A current replication circuit for a DC-DC boost converter to avoid a leading edge blanking (LEB) period restriction, the DC-DC boost converter regulating an output voltage by switching an input voltage through an inductor and a diode using a switch controller employing current feedback control and providing a pulse-width modulation (PWM) signal to control a switch coupled to the inductor, the current replication circuit comprising:
a current sensor that samples current through the inductor while the switch is off and that provides a sample voltage indicative of inductor current just before the switch is turned on;
a ramp generator that provides a ramp voltage replicating current increase of the inductor while the switch is on; and
a summing device that adds said sample voltage to the ramp voltage to develop a replication voltage used for feedback current control by the switch controller.

2. The current replication circuit of claim 1, wherein said current sensor comprises a sample and hold device that samples said current through the inductor before switching and that holds said sample voltage after switching of the switch.

3. The current replication circuit of claim 2, further comprising:
a current mirror, for coupling to the diode, that provides a mirror current indicative of current through the diode; and
said sample and hold device, coupled to said current mirror, that samples and holds a sample of said mirror current as said sample voltage.

4. The current replication circuit of claim 3, the switch controller providing a preliminary PWM signal and a buffer receiving the preliminary PWM signal and providing the PWM signal, wherein said sample and hold device holds said sample voltage in response to said preliminary PWM signal.

5. The current replication circuit of claim 1, wherein said ramp generator develops said ramp voltage based on the input voltage divided by the inductance of the inductor.

6. The current replication circuit of claim 1, further comprising a gain block which multiplies said replication voltage by a scale factor and provides a voltage sense signal to the switch controller for current feedback control.

7. A DC-DC converter, comprising:
an inductor having a first end and a second end, wherein said first end receives an input voltage relative to a common node;
a diode having an anode coupled to said second end of said inductor and a cathode;
a capacitor, coupled between said cathode of said diode and said common node, which develops an output voltage;
a switch device, having a controlled current path coupled between said second end of said inductor and said common node and having a control input, said switch device enabling said current path when turned on and disabling said current path when turned off;
a switch controller having an input receiving a current sense signal and an output providing a pulse-width modulation (PWM) control signal to said control input of said switch device;
a ramp generator providing a ramp signal having a slope that simulates current increase through said inductor while said switch device is turned on;
a current sensor that provides a current sample signal indicative of the current level through said diode while said switch device is off and just before said switch device is turned on; and
a summing device that adds said ramp and current sample signals to provide a replication signal used for said current sense signal.

8. The DC-DC converter of claim 7, wherein said switch device comprises a metal-oxide semiconductor, field-effect transistor.

9. The DC-DC converter of claim 7, wherein said current sensor comprises a sample and hold circuit that samples current and that holds a sample voltage as said current sample signal indicative of sampled current.

10. The DC-DC converter of claim 7, further comprising:
a current mirror coupled to said diode and providing a mirror current; and
said current sensor comprising a sample and hold circuit, coupled to said current mirror, which samples said mirror current and which holds a sample voltage as said current sample signal indicative of sampled current.

11. The DC-DC converter of claim 10, wherein:
said switch controller comprises a buffer having an input receiving a preliminary PWM signal and an output providing said PWM control signal; and
said sample and hold circuit receiving said preliminary PWM signal and holding said current sample signal in response to said preliminary PWM signal.

12. The DC-DC converter of claim 7, further comprising a gain block that multiples said replication signal by a scale factor to develop said current sense signal.

13. A method of eliminating the leading edge blanking period restriction of a DC-DC boost converter, the DC-DC boost converter regulating an output voltage by switching an input voltage through an inductor and a diode using a switch controller employing current feedback control and providing a pulse-width modulation (PWM) control signal to control a switch coupled to the inductor and the diode, the method comprising:
determining current level of the inductor while the switch is open and just before the switch is closed and providing a corresponding current level signal;
synthesizing current increase of the inductor while the switch is closed and providing a corresponding ramp signal; and
adding the current level and ramp signals to develop a current feedback sense signal provided to the sample controller.

14. The method of claim 13, further comprising:
generating a preliminary PWM signal; and
buffering the preliminary PWM signal to provide the PWM control signal.

15. The method of claim 14, wherein said determining current level of the inductor comprises sampling current and holding a current sample in response to the preliminary PWM signal.

16. The method of claim 15, wherein said sampling and holding includes converting sampled current to a voltage sample.

17. The method of claim 15, wherein said buffering the preliminary PWM signal includes delaying the PWM control signal to ensure sampling before switching.

18. The method of claim 13, wherein said synthesizing current increase of the inductor comprises generating the ramp signal based on the input voltage and the inductance of the inductor.
